(19) United States
(12) Patent Application Publication
(10) Pub. No.: US 2026/0059505 A1
(43) Pub. Date: Feb. 26, 2026

(54) MITIGATING RADIO DE-SENSE FOR CO-LOCATED RADIOS IN WIRELESS NETWORKS SUPPORTING TRAIN CONTROL

(71) Applicant: Meteorcomm, LLC, Renton, WA (US)

(72) Inventor: Derek Edmondson, Renton, WA (US)

(21) Appl. No.: 19/305,648

(22) Filed: Aug. 20, 2025

Related U.S. Application Data
(60) Provisional application No. 63/685,211, filed on Aug. 20, 2024.

(51) Int. Cl. H04W 72/0446

(52) U.S. Cl. CPC H04W 72/0446

(57) ABSTRACT

Methods for mitigating radio de-sense between co-located radios for digital wireless communication systems for railroads. One of the co-located radios handles application-context traffic that may, at times, have higher priority wireless traffic on a first channel that is centrally managed. It is “protected” from radio de-sense caused by transmissions of a second radio on a second channel that is not centrally managed or synchronized with the first channel. The protecting radio learns the ID of the protected radio, determines when the protected radio might receive wireless packets of higher priority on the first channel and inhibits transmissions on the second channel during these times.

### RELATED APPLICATIONS

This application claims the benefit of U.S. Provisional Application No. 63/685,211, titled Mitigating Radio De-Sense for Co-Located Radios in Wireless Networks Supporting Train Control, filed Aug. 20, 2024, which is incorporated herein by reference for all purposes.

### FIELD OF INVENTION

The disclosure pertains generally to mitigating radio de-sense between co-located radios for digital wireless communication systems used by railroads.

### BACKGROUND

Rail systems, whether freight or passenger rail, are complex systems that require management of the movement of thousands of pieces of equipment over many miles of rail. Signal systems assist with coordinating these movements by providing instructions to locomotive engineers and feedback to dispatchers about vehicle movement. Train control systems enable dispatchers in central offices, network operations centers, and regional dispatch offices to control the movement of trains and other railroad vehicles on railroads by monitoring and controlling interlockings and traffic flow on the tracks. Signal indications provide authorization to trains to move on a block of track. Various systems can be employed to ensure that wayside devices, such as switches, are correctly set before and during train movement through a track block and to collect status information from signals and switches and other types of wayside devices, such as rail integrity and track circuits and hazard detectors. Positive Train Control (PTC) systems are a type of train control system or collection of such systems that function to reduce the risk of train-to-train collisions, over-speed derailments, and casualties or injuries to roadway workers (for example, maintenance-of-way workers, bridge workers, signal maintainers) operating within their limits of authority because of an unauthorized incursion by a train. PTC systems can also prevent train movements through a switch left in the wrong position.

PTC systems add to existing systems an additional layer of control requiring the transmission of train control messages between existing functional subsystems for controlling the movement of trains and other vehicles on railroads. Examples of such functional subsystems are wayside units, examples of which include crossing signals, switches, and interlocks; mobile units such as locomotives, service vehicles, and other equipment that travel on the railways and their onboard controllers; and systems in central and back-office systems. PTC systems include equipment on the rail vehicle, equipment in the control center, equipment on the rail wayside, and wireless communication between all three elements. Global positioning systems (GPS) provide location information of each vehicle to the control center. The PTC system reviews speeds, track conditions, and vehicle locations and determines braking curves for each vehicle. The system alerts the vehicle crew if a condition requires the train to slow or stop. If the crew does not respond, emergency braking is automatically applied. The Rail Safety Improvement Act of 2008 (RSIA) mandates the implementation of PTC systems on many of the main lines of Class I railroads and on any main lines over which intercity or commuter rail passenger transportation is regularly provided.

An interoperable train control system allows for locomotives of host and tenant railroads to communicate with and respond to a PTC system while supporting uninterrupted movements over property boundaries. An interoperable train control communications system that supports inter-operative PTC will typically include a back-office server (BOS) and an onboard locomotive-centric train control system that enforces a train's authority limits, permanent speed restrictions, and temporary speed restrictions. The onboard system includes a train management computer (TMC) that interfaces with the locomotive's braking system and other systems. The communication processes of the system are expected to support non-critical communications but prioritize safety-critical message delivery with multiple, reliable communications paths between various elements of the railroad. Each of these paths should also support the exchange of different types of information while meeting the wireless regulatory requirements imposed by the FCC and the stringent requirements of interoperable PTC.

A nationwide interoperable train control messaging (ITCM) system is currently used by back-office applications that implement Centralized Train Control (CTC), interoperable PTC, and other systems or applications used by railways in North America to exchange application messages between computers in railroad back offices, locomotives, and wayside areas without knowing routing or other the details of the underlying networks that are used to transport the messages. ITCM supports the use of different types of transport networks. However, a 220-MHz wireless digital packet radio network called ITCnet® is currently the only nationwide RF interoperable transport for the ITCM messaging system. An interoperable transport is one that enables direct communications between the remote asset of one railroad (for example, a locomotive) and a back office of another railroad using the ITCM messaging system.

The air interfaces and operation protocols of the 220 MHz radio network are described in the specifications titled ITCR 1.1 System Architecture, published in 2012 by Meteorcomm LLC, and ITCnet Common Air Interface, published in 2013 by Meteorcomm LLC. The specification is incorporated herein by reference for all purposes. U.S. Pat. Nos. 8,340,056 and 8,605,754, which are incorporated herein by reference for all purposes, also describe various aspects of the ITCR protocols.

The ITCnet network has hundreds of base stations dispersed geographically over thousands of square miles. The base stations are configured to communicate with central or back offices over backhaul networks. Each base station has a base radio configured to communicate wirelessly with remote radios within its coverage area, such as remote radios that are part wayside monitoring subsystems and remote radios in mobile assets such as locomotives. A “remote radio” refers to a radio that is not at a base station. Remote radios are, for example, radios on locomotives, other railroad vehicles, and other mobile railroad assets, as well as radios at railroad assets at fixed locations such as wayside monitoring subsystems connected with wayside units. Remote radios associated with wayside monitoring subsystems transmit monitoring information to back or central offices through a base station within range. Wayside remote radios also transmit monitoring information directly to locomotives in their vicinity.

ITCnet supports a communication path between waysides and central offices, which is expected to support signal system health and status monitoring, centralized control of control points, wayside defect detection system data, and alarms. ITCnet also supports a direct communication path between a remote radio on a locomotive and a remote radio at a wayside that provides prompt and reliable delivery of wayside status updates to any locomotive in the proximity of the wayside. A train generally requires a status update from each wayside it approaches. Current standards mandate that the age of a status of a wayside within 3.5 miles ahead of a train must not exceed 12 seconds with 99.9999% reliability.

The channel plan for the ITCnet 220 MHz network includes fourteen 25 MHz channels, each of which provides a communication path in both directions between two connected radios but in only one direction at a time. Each channel supports both transmission from the base radio and transmission from the remote radios, but not simultaneously. ITCnet base and remote radios, meaning radios configured to receive and transmit digital RF packets on the 220 MHz network, are expected to be capable of simultaneously receiving and processing signals on multiple channels.

The 25 kHz channels available in a geographic area can be assigned one of four channel types.

A “Common” channel is used for network discovery and emergency traffic. All base stations and remotes share the common channel. In ITCnet, each remote radio is assumed to be capable of receiving wireless packets concurrently on multiple channels and thus able to listen to multiple base stations on different local channels in its vicinity. However, a remote radio may select only one base station to be its serving base station. All base and remote radios within an area are configured to use the common channel for network discovery and emergency traffic. A packet transmitted in the common channel is typically a short packet that carries very high-priority data.

A “Wayside” channel is currently used for the delivery of wayside status messages transmitted from transmission facilities at fixed locations and intended for consumption primarily by moving locomotives.

A “Local” channel is assigned to each base radio using a cellular frequency reuse schema. It is used for routine and interoperable PTC traffic flow between remote radios and a federated network of back offices and for other purposes. It is also used to schedule transmissions on the local channel to and from remote radios that have registered with the base radio. The controlling base radio manages the use of its assigned local channel by remote radios within the coverage area of the base radio.

A “DirectRF” channel is set aside for remote radios to directly communicate with each other without the assistance of a base radio or dependence on the transport network facilities of a federated network of back offices.

ITCnet currently supports three channel access schemes that allow for base radios and remote radios to share a channel: Fixed Time Division Multiple Access (FTDMA), Dynamic Time Division Multiple Access (DTDMA), and Carrier Sense Multiple Access (CSMA). FTDMA and DTDMA are variations of the common time divisional multiple access (TDMA) method in which access to a channel is divided into time slots for allocation to radios to transmit on the channel without interference from other radios. Other train control radio networks might use fewer or additional access schemes for sharing transmission resources for a channel.

Common channels and DirectRF channels are shared using CSMA. CSMA is a peer detection scheme used to avoid collisions of transmissions from multiple radios trying to access a shared channel at the same time. In CSMA, a radio randomly senses the state of the channel when wanting to transmit and immediately transmits if it is free.

Referring to FIG. 1A, local channel resources are shared using FTDMA and DTDMA as represented by the figure. In ITCnet, time slots on a local channel are organized into a repeating superframes 10 that have a fixed duration or length throughout the ITCnet wireless network. Each superframe is currently partitioned between an FTDMA frame 12 and a DTDMA frame 14. Each superframe starts with one FTDMA cycle 16 in the FDTDMA frame 12, followed by at least one and typically several DTDMA cycles 18a to 18n in the DTDMA frame 14.

Time slots (not shown) in the FTDMA frame are configured during setup. The FTDMA frame and cycle are used to support constant periodic traffic from radios. The length of the FTDMA frame and cycle and allocation and assignment of time slots in an FTDMA cycle 16 are configured during set up and remain fixed unless changed by a network administrator or operator during a configuration or set up process. A fixed number of FTDMA slots, each with a fixed slot size, are typically allocated to a radio at a fixed repetition rate.

Allocation of time on the local channel during the DTDMA frame is centrally managed by a base radio to which the local channel is assigned. The base radio for a local channel is sometimes referred to as the “serving base radio” for the channel. The base radio uses the local channel to allocate and assign times to transmit on the local channel to itself and to remote radios registered with the base radio.

A representative example of how a base station could organize DTDMA cycle 18a is shown in the figure for purposes of explaining how ITCnet permits a base radio to organize using fields 20 and slots 21. However, because the organization is dynamic, the configuration of cycles, fields, and slots can be different in each cycle. Packet transmission timeline 19 in the figure is a representative, nonlimiting example of packets that could be transmitted within the organization of DTDMA cycle 18a.

The length of the DTDMA frame is fixed during setup. However, the length and number of each DTMDA cycle 18 during a DTDMA frame is determined by the base radio and can vary between DTDMA frames. The base radio organizes time slots in each DTDMA cycle using fields. The DTDMA frame in ITCnet currently specifies five fields: a control (CTL) field 22, a base radio transmit (B-TX) field 24, a remote transmit (R-TX) field 26, a high-priority CSMA (HP-CSMA) field, and an all-priority CSMA (AP-CSMA) field 30. The base radio sets the length of each field. The length of each field may vary between DTDMA cycles.

The DTDMA time slots are used to support traffic between the base radio and remote radios connected to it. Each time slot is used to transmit one RF packet. Each DTDMA time slot is a multiple of a DTDMA slot unit (DSU) 31, which is a basic time element used in a DTDMA frame. The serving base radio may assign a time slot to itself or a remote radio, or it may designate a time slot as being accessible by any remote radio using CSMA to transmit an RF packet to the base radio. At the beginning of each DTDMA cycle in a DTDMA frame, the base station broadcasts a DTDMA control packet 33 during the control field 22 that organizes transmissions in the cycle. The length of the control packet and thus also the control field is set by the base radio and can vary between DTDMA cycles. The base radio may allocate zero DTDMA time slots to the B-TX, R-TX, HP-CSMA, and AP-CSMA fields. There is currently no requirement in ITCnet that each DTDMA cycle allocate time to each of these fields.

The control packet is followed by DTDMA time slots organized into the four remaining fields. A DTDMA time slot is currently one of three types: a base transmit (B-TX) slot 32, a remote transmit (R-TX) slot 34, and a CSMA slot 36. Other types of fields and slots could, optionally, be specified and supported in future versions of ITCnet. Each time slot is used to transmit one RF packet, which can be one of two basic types: a data packet that carries application-level messages or data or a control packet. A data packet can be unicast or broadcast. There are currently several different control packet types supported by ITCnet including DTDMA control (CTL) packets 33.

A B-TX or base radio transmit time slot is assigned by the base station to itself to transmit a B-TX RF data packet 38. A B-TX time slot can have any length that is a whole number multiple of a DSU. The length is set by the base radio and can vary between B-TX within the same field and between cycles. The base radio will typically set the length of a B-TX time slot based on the length or amount of data that needs to be transmitted. The outbound data is usually unicast data, meaning that it is intended for consumption by a specific remote radio. However, may also be broadcast data packet intended for consumption by all remote radios. An “R-TX” or remote radio transmit slot is assigned to a specific remote radio to send data to the base radio. The base radio schedules an R-TX slot for the remote radio to transmit an R-Tx packet 40 and publishes the schedule of all assigned R-TX time slots for the DTDMA cycle in the DTDMA control packet at the start of the cycle. The base radio may set the length of an R-TX time slot assigned to a remote radio based in part on the amount of data or length of the message that the remote radio needs to transmit to the base radio. A CSMA time slot 36 has a fixed length, which is whole number multiple of a DSU. It can be used by a remote radio to transmit an RF control packet to the serving base radio to request an R-TX slot. The base radio allocates the CSMA slots but does not assign them to remote radios. A remote uses CSMA to access the local channel during a CSMA slot to transmit the RF control packet. A remote radio may use multiple CSMA time slots 36 to transmit an RF packet 42.

The control field 22 always has a control slot 31 of non-zero length. The total number of time slots in a field and cycle depends on the length of each time slot in each field and the number of fields that have time slots. The base radio transmit (B-TX) field 24 may have zero or more B-TX slots 32 for carrying outbound data traffic in RF packets from the base radio to remote radios. A remote transmit (R-TX) field 26 may have zero or more R-TX slots 34 for carrying inbound data traffic from remote radios to the base radio. A high-priority CSMA (HP-CSMA) field may have zero or more CMSA slots 36 reserved for use by a remote radio to request an R-TX time slot on the local channel to transmit high-priority data to the base radio. An all-priority CSMA (AP-CSMA) field 30 has zero or more CMSA slots 36 reserved for use by a remote radio to send a packet in a CSMA slot to request an R-TX time slot to access the local channel to transmit to the base radio data of any priority.

It is not uncommon for multiple wireless network train control radios, such as 220 MHz ITCnet radios, to be co-located in a remote area such as a locomotive. Co-located radio transmission facilities create the potential for co-located transmission facilities to interfere with transmissions. The term “transmission facility” refers to a transmitter, receiver, antenna, amplifier, band-pass filter, band-reject filter, or auxiliary equipment. It may also refer to a colocation facility in which multiple radio transmission facilities are co-located. “Transmission” refers to a transmitting operation, a receiving operation, or both.

Several approaches have been used to mitigate the risk of radio interference between radios. For example, in the case of disparate radios that are sharing radio resources, radio resources include radio frequencies, radio transmission power, timing of radio transmissions, radio equipment location, and separation of transmission facilities—but not transmission facilities, carrier-detection and decoding of subaudible signals has been used. Detection of a subaudible signal can be used to illuminate a “busy channel” indicator to alert a user of a radio that someone else is using the channel. In so-called “busy-channel-lockout” implementations, detection of the signal also temporarily inhibits the radio transmission facility, thus preventing it from transmitting when another facility is transmitting on the same frequency. Another approach involves the use of subaudible analog tones and subaudible digital codes that are modulated along with the audible voice or frequency-shifted modem data traffic to control receiver squelch.

Coordinating the sharing and reuse of radio resources is another approach. A single control system manages the sharing of channel resources disparately located but technologically compatible equipment. This requires the use of a “control layer” to manage the sharing of channel resources. The control layer requires the transmission of messages, called “control plane traffic,” to manage the sharing of radio resources by users, referred to as “user plane traffic.” The control plane traffic and user plane traffic need not be on the same traffic channel (whether frequency or time domain). It was used initially in trunked radio systems and, later, cellular telephone systems. It is the basis for many currently established mobile wireless voice and data radio access networks. ITCnet currently uses this type of approach to managing interference for local channels.

However, these various approaches do not protect co-located radio transmission facilities from radio interference, referred to as “radio receiver de-sense.” Radio receiver de-sense is caused by one of the co-located radio transmission facilities transmitting while another of the co-located transmission facility is receiving. In other words, transmission by one radio interferes with the receiving of other co-located radios, even though the respective transmissions are on separate radio frequencies and each radio is operating within applicable system specifications and legal limits. In this context, two radios are co-located when the radios are physically close enough that one can cause radio receiver de-sense interference with the other. One method to mitigate radio receiver de-sense between co-located radios at a transmission facility involves adding receivers, called “guard receivers,” to detect when transmissions are occurring on a channel that one of the co-located radios is receiving and locking out a co-located radio to prevent it from transmitting on a different channel. However, this approach does not prevent simultaneous attempts by the co-located radios to acquire radio resources.

In the context of ITCnet, not synchronizing local channels between base radios adds to the risk of radio receiver de-sense between co-located radios. Busy-channel-lockout and managed access are less likely to protect co-located radio transmission facilities from radio receiver de-sense in this situation. Furthermore, radio receiver de-sense is possible when, for example, a remote radio on board a locomotive is transmitting on the Direct RF Channel, access to which is not managed, with a second radio co-located on board the locomotive trying to receive transmissions on another channel with centrally managed access.

### SUMMARY

Disclosed below are representative examples of methods and apparatus, aspects of which may be used to reduce de-sense interference between co-located radios or, more generally, co-located RF transmission facilities for wireless radio networks used by railroads to transport messages for railroad applications, such as train control messages. Any one or more aspects of any of the disclosed methods and apparatus can be used, for example, to support simultaneous use of two or more different channels within the same geographic area by co-located RF transmission facilities, including on one or more channels that are centrally managed and one or more channels that are not centrally managed, while protecting one of the co-located radios from radio de-sense interference when it might be receiving higher priority traffic.

In a representative, nonlimiting embodiment, two or more radios co-located in a railroad area are configured for communication over wireless radio networks used by railroads to transport messages for railroad applications. A first of the co-located radios might handle, for example, application-context wireless traffic received on a first channel centrally managed by a base radio that could at times have higher priority than traffic being transmitted on a different, second channel by a second of the co-located radios. The protecting radio is configured to learn the ID of the protected radio, determine times when a base radio is or, optionally, might be transmitting to the first radio of the first channel wireless packets of higher priority, and inhibit itself transmitting on the second channel during these times. During these times, the second radio may protect the first radio from radio de-sense interference by inhibiting itself from transmitting on the second channel, at least when it has no data traffic to transmit that might have an even higher priority than the data traffic on the first channel it is giving priority to, such as emergency traffic of high importance and/or high sensitivity to latency or delay. The second channel does not need be centrally managed or, even if it is managed, synchronized with the first channel.

### BRIEF DESCRIPTION OF THE DRAWINGS

FIG. 1A illustrates an example of an air interface protocol for a wireless train control network.

FIG. 1B is a schematic representation of basic functional subsystems or components of a railroad control system.

FIG. 2 is a flow chart illustrating an exemplary embodiment of a protected radio process for a method to mitigate de-sense interference to a protected radio caused by a protecting radio.

FIG. 3 is a flow chart illustrating an exemplary embodiment of a process for a protecting radio to track a protected radio to mitigate de-sense interference to a protected radio caused by a protecting radio.

FIG. 4 is a flow chart illustrating an exemplary embodiment of a process for protecting radio communications on a direct channel.

FIGS. 5-10 are representative examples of time distribution allotments of local channel control packets for a method to mitigate de-sense interference to a protected radio caused by a protecting radio.

### DETAILED DESCRIPTION OF EXEMPLARY EMBODIMENTS

In the following description, like numbers refer to like elements.

The description uses scenarios in which the RF network for train control has channel types that are analogous to or like at least the ITCnet local channel (centrally managed by a base station) and direct RF channel (contention-based access scheme that is not time divided) and, optionally, wayside, and common channels. The term “local channel” will refer to a channel managed by a base station using a time division, multiple access scheme, and, in the context of ITCnet, to an ITCnet local channel. A “direct channel” is one used primarily for communications between remote radios, access to which is managed by a contention-based access scheme such as CSMA. In the context of ITCnet, the term direct channel refers to an ITCnet direct RF channel. The methods can be used or adapted for use in other digital RF networks for transporting railroad application messages to mitigate radio receiver de-sense.

Unless indicated otherwise, the following terms have the ascribed meanings in the description of the figures.

A “radio” refers to a device that includes a radio frequency transmitter, a radio frequency receiver, or both. A “remote radio” refers to a radio that is not at a base station radio. A base station radio will be referred to as a “base radio.” A remote radio may be fixed or mobile. A “transceiver” refers to a device that has both an RF transmitter and an RF receiver. A transmitter and receiver of a radio may, but do not have to, share analog RF stage components, such as antennas, amplifiers, and mixers. Similarly, they may share processors, user interfaces, network interfaces, and other I/O components. Multiple transmitters and/or multiple receivers may also share components.

A radio can be implemented using conventional hardware radio circuits or as a software-defined radio (SDR). An SDR transmits, receives, and processes information in a binary digital form, meaning as a series of bits. It uses software to implement at least some conventional components and processes that conventional radios implement using analog components. For example, an SDR will typically implements certain conventional components such as modulators, demodulators, filters, mixers, and others, using software running on a processer or other programmable hardware circuit, examples of which a digital signal processor (DSP), field programmable gate arrays (FPGA), and general-purpose processors. An SDR will usually also have additional hardware, such as memory for storage, radio frequency amplifiers, analog to digital (ADC), and digital to analog (DAC) converters, interfaces, and power supplies. They may use components in which multiple digital and some analog circuits are integrated into a single, monolithic substrates or “chips.” An SDR provides several advantages, including multi-channel capability and the ability to adapt to different channel conditions.

A “rail vehicle” refers to any type of transportation vehicle configured to travel on railroad tracks. A “locomotive” is a type of rail vehicle that provides power to move a series of connected rail vehicles (a “train”) on a railroad. A “car” or “railroad car” generally refers to a rail vehicle for carrying passengers or freight. A “hi-rail” refers to a vehicle or machine capable of traveling on roads or over the ground that has been converted or is capable of being converted to travel on railroad tracks.

A “back office” (BO) refers to one or more facilities containing computer or data network infrastructure that support railroad operations, including computing systems hosting servers for railroad applications. A “central office” (CO) generally refers to one or more facilities from which dispatchers of railroad monitor and authorize the movement of trains and other rail vehicles on its tracks. A railroad may have a network operations center (NOC) that oversees and controls traffic on all its tracks. The same facility may function as a BO, CO, and NOC. A reference to one of these facilities should be interpreted as a reference to any of them unless contrary to the context.

The following description of the figures assumes that the remote radio and base station radios are digital packet radios. However, the methods could be adapted for use with other types of radios. A digital packet radio means that the radios transmit, receive, and process packets of information in a binary digital form. Such radios are typically implemented as an SDR. An SDR provides several possible advantages, including multi-channel capability and the ability to adapt to different channel conditions. Thus, for example, a remote radio with multi-channel capability on the locomotive enables it to receive information from a base station and a wayside monitoring subsystem simultaneously. Additionally, an SDR can also allow a locomotive and base stations to receive status messages from multiple wayside monitoring subsystems. This capability enables support for communications with a high density of waysides in city areas. U.S. Pat. No. 8,340,056 and US published patent application no. US20230138011A1 disclose representative, nonlimiting examples of SDR radios and are incorporated by reference herein for all purposes. A representative, nonlimiting example of an SDR for ITCnet is disclosed by U.S. Pat. No. 8,340,056, which is incorporated herein by reference for all purposes.

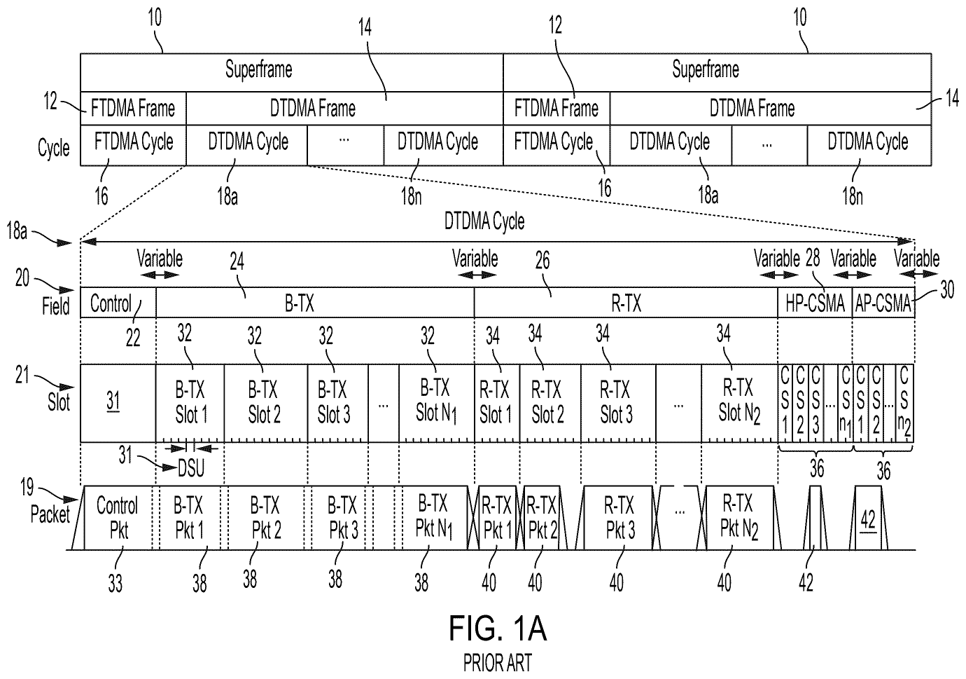

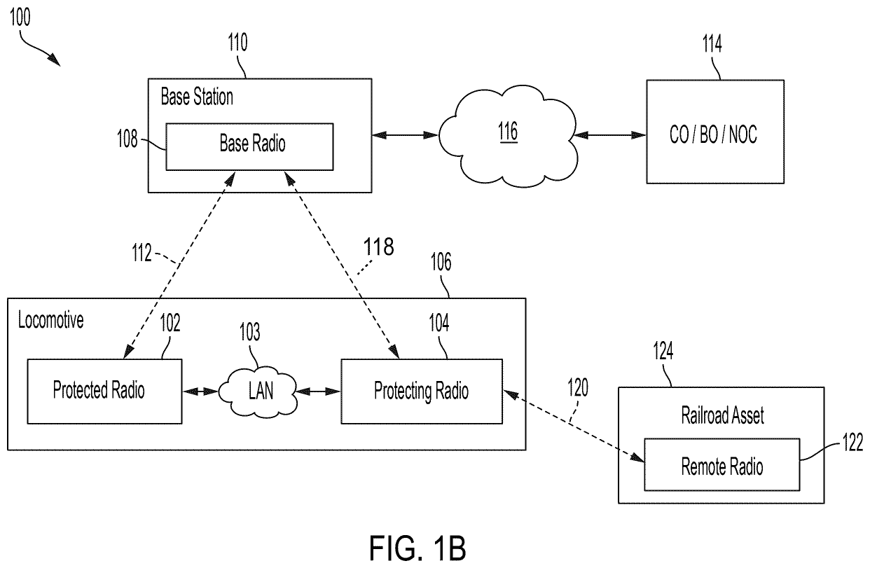

Referring to FIG. 1B, which is a representative, nonlimiting example of a usage scenario for a railroad digital RF communication network 100 for railroads. A first radio 102, which will be referred to as “protected” radio, and a second radio 104, which is configured as a “protecting” radio, are co-located on locomotive 106. The locomotive is a representative example of a railroad asset that could have co-located transmission facilities. The locomotive may have additional co-located radios that are configured as protecting radios. The co-located radios are configured to send messages to each other or otherwise to communicate over, for example, a wired or wireless local area network (LAN) 103 or direct connection.

A protected radio can be, for example, a remote radio used for transmitting or receiving higher priority messages, including for example operation-critical messages that a transmitted by a base radio 108 of a base station 110, with which it has set an RF communications link represented by dashed line 112. The protecting radio can be, for example, a radio used primarily for transmitting messages having a relatively lower priority. Thus, the protected radio in this scenario could the radio onboard the locomotive that is ultimately responsible communications with railroad application and systems that enforce train movement and can be, for example, located in a back office (BO), central office (CO), or network operations center (NOC), which are collectively represented by block 114. Cloud 116 represents networks that interconnect each base station 110 with the railroad application servers located in back offices, central offices, network operations centers, or data centers.

Protecting radio 104 could, for example, be used for communicating data or messages for lower priority functions such as radios participating in end-of-train systems, distributed power systems, and grade crossing assistance systems. In this scenario, radio receiver de-sense interference could occur when the protecting radio transmits during on an ongoing transmission of an RF signal that the protected radio is attempting to receive. Protecting radio 104 may receive from and transmit to the base radio 108 on its local channel, as represented by broken line 118. Protecting radio 104 may also communicate with remote radio 122 at railroad assets 124 over a direct channel represented by broken line 120.

To reduce the risk of radio receiver de-sense interference that would interfere with the protected radio's reception use of one or more channels due interference caused by a protecting radio transmitting at the same time on a different channel, limits are placed on when the protecting radio may transmit on different channel. In one embodiment, the protecting radio is made aware of resources allocated to the protected radio's reception on one or more channels and is programmed not to transmit on a different channel during these periods.

A representative, nonlimiting embodiment of a method of mitigating de-sense interference includes identifying a first radio as a protected radio; configuring a second radio co-located with the first as a protecting radio, establishing a time framework that includes one or more periods, during which the protecting radio is not permitted to transmit, and communicating the one or more periods to the protecting radio.

In ITCnet, the protected radio might be engaged in sparse reception and transmission of traffic on the Common Channel, intense reception of traffic on a Wayside Channel, intense reception with occasional transmission of traffic on the Local Channel, and sparse reception and transmission on the Direct RF Channel. When the protected radio uses a local channel managed by base radio 106 of base radio 108, the protected radio does not need to know the allocation of resources of the Local Channel for any purpose other than acquisition of resources to transmit on the Local Channel, to receive traffic addressed to it from a back office, and to maintain connectivity to the radio network. The protected radio 102 need not be interested in the allocation of RF resources of the local channel other than, for example, the acquisition of resources for it to transmit on the local channel, receive traffic addressed to it arriving from a back office, and maintaining connectivity to the radio network.

The protecting radio 104 might, for example be actively involved in exchanging traffic with other remote radios, such as remote radio 122, via a Direct RF Channel and otherwise uninterested in traffic carried on the Wayside Channel or the Local Channel.

To reduce the risk of the protecting radio causing de-sense interference of the protected radio by transmitting while the protected radio is trying to receive an RF signal transmitting a digital packet that at least might be higher priority, the protecting radio is configured to determine time and scheduling constraints on its use of radio resources based on its awareness of allocations of radio resources for transmitting data to the protected radio. In the scenario described above, the protecting radio determines when it should not transmit on a first channel, such as a Direct RF Channel, to protect reception by the protected radio of RF signals that might be carrying higher priority digital packets intended for consumption by the protected radio on a second channel, such as a Local Channel. Examples of such higher priority packets may include those used for any one on or more of the following purposes: acquiring resources for it to transmit data to a back office; receiving traffic from a back office; and maintaining connectivity to the radio network.

In ITCnet, for example, the protected radio can be an ITCnet radio installed in a locomotive, referred to as a PTC-220 radio, which is ultimately responsible for participating in train movement enforcement for Positive Train Control. The protected radio could be, for example, a second ITCnet radio in the locomotive being used for other purposes that relate to train movement, such as communications for end-of-train units, distributed power operation, and grade crossing assistance.

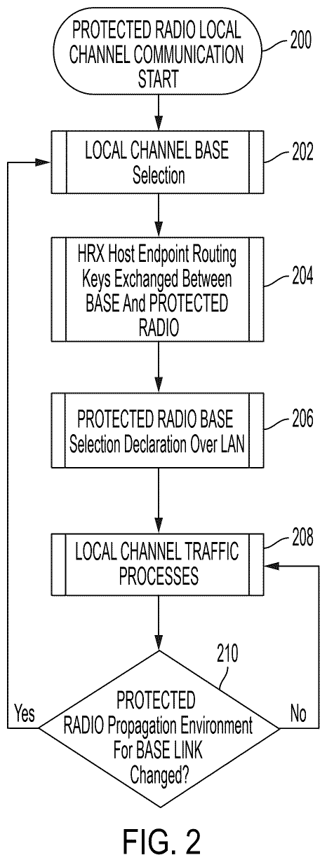

FIGS. 2 to 4 are flow charts to illustrate representative, nonlimiting processes for mitigating radio de-sense interference in a train control network, using an ITCnet® radio network implementation as an example. The processes contemplate at least two remote radios collocated in a remote area such a locomotive, which are connected to a local area network in the remote area. One of the remote radios is designated as a protected radio and at least one of the remote radios is designated as a protecting radio.

The illustrated processes do not depend on how each radio is designated. Designation can be made using several different methods. For example, each radio could be configured to default being neither a protected or protected radio, a protected radio, or a protecting radio. Each protected remote radio is programmed to perform at last the protected radio processes. Each protecting radio is programmed to perform least the protecting radio processes. Programming is one way to configure and thus designate a radio as a protected or protecting radio. However, a radio could be programmed to be capable of performing both set of processes, which the performed processes depending on its configuration. The configuration could be, for example, stored in, for example, memory of the radio or using means, such as switches. This configuration could be stored set when the radio is made, installed, or updated. Alternatively, or in addition, the configuration of the radio as a designated protected or protecting could be set or changed or in response to the receipt of an instruction or message or based one or more predetermined conditions.

Referring first to FIG. 2, a protected radio is programmed to carry out processes according to process 200 to start communication on a channel controlled by a base radio, which is the Local Channel in ITCnet. At block 202, the protected radio selects the local channel of the base radio to set up a new RF link with.

At block 204 the protected radio and the base radio exchange information updating the route used by the messaging system to the remote area where the protected radio is located. The updating depends at least in part on the messaging system used by a train control network and thus is optional in other implementations. In ITCnet, establishing an RF link between a base station and a remote radio is a path or route that is available for transporting application messages to the remote radio. In the ITCnet network, the process of updating routing information involves exchanging HRX host endpoint routing keys. HRX refers to a published protocol called Host Radio Exchange, which is a wire protocol used by a software application running on a local host, usually with other components of the ITCM messaging system, to communicate with an ITCnet radio over an ethernet connection. The application is, in ITCnet, referred to as a communication manager (CM) for a remote radio or external link manager (ELM) for a base radio. It functions as a bridge between an interoperable RF transport provided by ITCnet—the RF communications link between a base radio and a remote radio—and the ITC messaging system (ITCM) and hides the details of the underlying transport from the messaging system. In non-ITCnet implementations, the remote radio would select and connect with a base station according to the applicable protocols.

At block 206, the protected radio communicates to the protecting radio information identifying the base radio to which the protected radio has connected. This information includes, for example, the unique identifier of the protected radio and the base radio. These identifiers are, in an ITCnet implementation, the ITCnet Radio ID of the protected radio and its serving base radio. A protecting radio that receives the message uses it determine whether it is connected to the same base station as the protected radio and, if not, to switch to the base station of the protected radio.

This base radio connection information can be, for example, communicated in a message of a predetermined message type or format that is sent over the local area network, to which the protected radio and the protecting are connected. For purposes of this description, such a message will be referred to as a base radio designation. The message may, optionally, be sent in an Ethernet multicast frame on the local area network so that it can be received by any protecting radio connected to the local network. A multicast message also allows the protected radio not to be aware of a protecting radio. The process 200 on the protected radio is configured to update base radio connection information when it connects to a new base radio, such as by sending and designation message once it connects to a new base radio. It may, optionally, also be configured to periodically send a designation message with information identifying the base radio to which it is connected current base radio. It may instead or in addition, be configured to send the message in response to one or more predetermined events, including, for example, a message sent on the local area network by a protecting radio requesting information from the protected radio or any protected radios in the remote area.

Block 208 represents normal local channel traffic processes of the protected radio that occur after the protected registers with the base station. The protected radio processes local channel traffic according to applicable protocols until the propagation environment for the link to the base radio requires selection of a new base radio due to the travel of the protected radio, as represented by decision block 210. The process 200 then returns to block 202 to select a new base radio and connect to it.

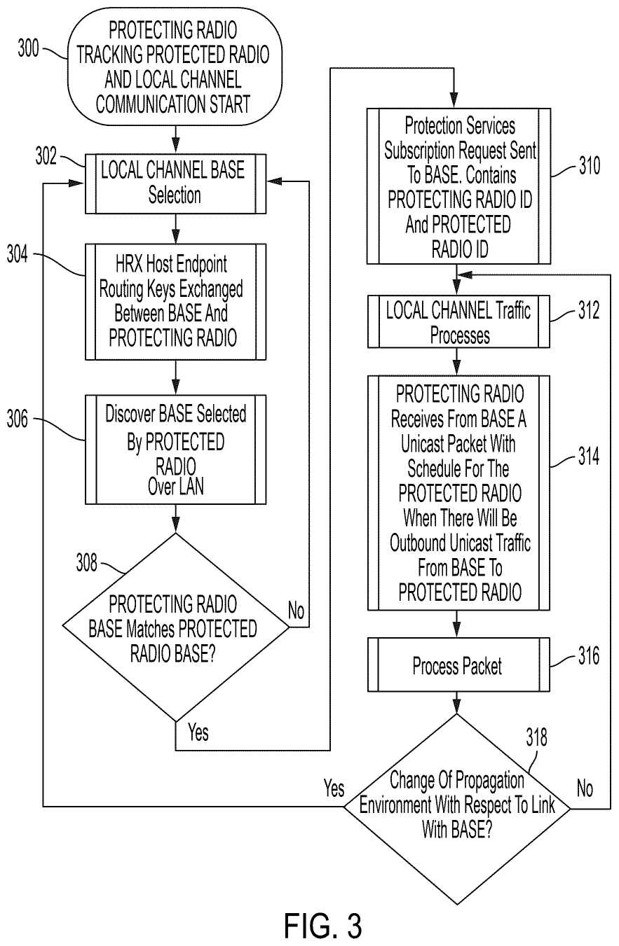

FIG. 3 represents processes 300 of the protecting radio for connecting to a base station. The process helps it to select and connect to the same base station as the protected radio. Like the protected radio at blocks 202 and 204 of processes 200 (FIG. 2), the protecting radio selects a local channel of a base station within its vicinity to register with and connects to it as represented by block 302. It, optionally, exchanges information for updating routes used by the messaging system to route messages to the protecting radio through the selected base radio, which is represented by block 304.

After connecting to a base station, the protecting radio goes through a process represented by block 306 to discover what base radio the protected radio has selected to determine whether it is connected to the same base station as the protected radio. In one embodiment, the discovery process includes waiting for and receiving a designation message from the protected radio over the local area network, as described above in connection with FIG. 2. Alternatively, or in addition, other methods of discovering the base station to which the protected radio is connected. If the protecting radio determines that its serving base radio is not the same as the protected radio's, the protecting radio repeats the process of selecting and connecting to a base radio, as represented by blocks 302 and 304, and checks at block 306 to confirm that its serving base station is the same as the serving base station of the protected radio. Blocks 302 and 304 are repeated until the protecting radio determines that it is connected to the same base station as the protected radio.

Once the protecting radio determines that it and the protected radio are assigned to the same base station, the process moves to block 310. In block 310, the protecting radio transmits an RF packet to the base station with a request to subscribe or turn on a protection service for the protected radio. The request identifies the protected radio and the protecting radio.

In an exemplary embodiment, the protecting radio transmits a unicast message to the serving base radio on its local channel that is a request to subscribe to a protection service for the protected radio. The packet may, for example, use a preassigned packet type code or contain information identifying it as a request to subscribe to a protection service using the radio identifiers or addresses of the protected radio and the protecting radio, which are ITCnet Radio IDs in the ITCnet example. The base radio logs this information and sets up a subscription service. This can be done, for example, by the base radio setting up a condition that will, for example, cause it to transmit to the protecting radio on the local channel a protection services packet containing one or more scheduled transmission times for one or more queued packets intended for consumption by the protected radio. In the ITCnet example, the protection service would, for example, include unicast RF packets that the base radio schedules for transmission do the protected radio. The protection services packet is, in this example, transmitted as unicast RF packet to the protecting radio. The protection services packet may, optionally, include scheduled transmission times for other types of packets intended for consumption by the protected radio. When the base radio schedules transmission of an RF packet intended for consumption by the protected radio, the base radio may, for example, be configured to schedule also a protection services packet to the protecting radio prior to the scheduled transmission time of the packet intended for the protected radio. The base radio may instead or in addition be configured to periodically send protection services packets to the protecting radio, even if no packets are scheduled for transmission to the protected radio. A protection services packet may, optionally, include an indication of the period for which any scheduled transmission times are included.

Block 312 represents standard radio processes of the protecting radio receiving and transmitting on the local channel according to applicable protocols for the radio network. These processes include receiving unicast packets from the base radio, addressed to the protecting radio.

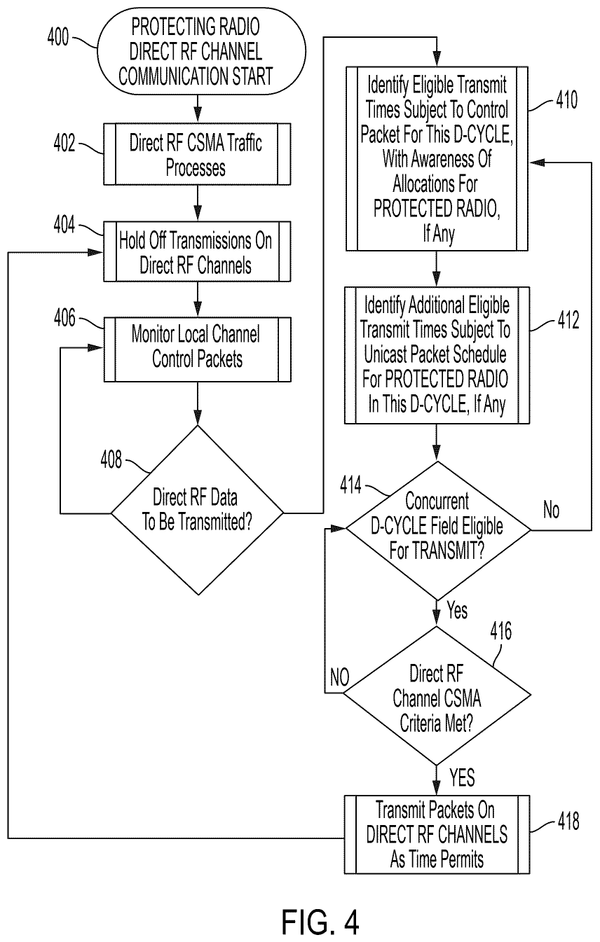

Block 314 represents standard radio processes of the protecting radio receiving a unicast packet generated by the protection service. Block 316 represents the protecting radio processing a received unicast protection services packet. This processing is described below in connection with FIG. 4.

As represented by decision block 318, the protecting radio will initiate a base radio selection process based on a change in the propagation environment of its link with the base radio that requires selection of a new base radio starting with block 302.

The discovery process represented by blocks 306 and 308 may, optionally, run in parallel with blocks 310-316 to initiate a base radio selection The protecting radio will continually be receiving any frames on the local area network that are multicast or addressed to it and process any enclosed designation message. It may, therefore, be programmed to initiate the base radio selection process starting with block 302 before there is a change in propagation environment and/or before or during the processes carried out at other blocks, including interrupting other processes.

FIG. 4 is a flowchart illustrating a representative, nonlimiting embodiment of processes 400 of a protecting radio, implemented by programming the protecting radio, to determine when it may transmit on direct channels during a concurrent DTDMA cycle of a local channel of a serving base radio to which the protected radio is connected. Only the describe contemplates only one protected radio, the method does not preclude the protecting radio protecting more than one co-located remote radio that is using the same channel or another channel that is used to transport higher priority traffic.

Processes 400 assume that the remote radio is capable receiving on multiple channels concurrently, including at least the local channel and at least one direct channel, and capable of transmitting in a least a half-duplex mode on the local and direct channels. The description will assume for simplicity that there is just one local channel managed by a base radio to which the protected radio is connected and a different, second channel that the protecting radio is using. Block 402 represents ongoing execution processes of the protecting radio to transmit and receive wireless packets on the second channel. This example assumes that it is a ITCnet DirectRF channel that uses CSMA.

The protecting radio will not transmit on the second channel unless it is monitoring the local channel of the base radio to which the protected radio is connected and determines that it may transmit on the second channel. Therefore, as represented by block 404, it holds off transmitting on the second channel, the ITCnet DirectRF channel in this example, while monitoring control packets transmitted on the local channel by the serving base radio, a represented by block 406.

In the illustrated embodiment, the protecting radio is aware of the base radio with which the protected radio is currently registered and its local channel. It is configured to processes the control packets on the local channel transmitted by the base radio. It may, for example, be configured to gain this awareness from the protected radio using a method like the one described above in connection with FIG. 3. However, other methods could be used. Although obtaining awareness of the base radio to which the protected radio is connected directly from the protected radio might have advantages in at least some circumstances, the protecting radio could obtain awareness of the protected radio's serving base radio in other ways. The protected radio is configured in this embodiment to consume each control packet transmitted on the local channel even when it is not actively using the local channel. Furthermore, the protecting radio may receive and process control packets on the local channel even if it has not registered or connected to the serving base radio. However, to receive, for example, protection services packets as described in connection with block 412, it will need to connect to the serving base radio for the local channel.

As represented by decision block 408, when the remote radio has a data to transmit on the second channel, it identifies times in which it may transmit, which are referred to as transmit-allowed or transmit-eligible times in this description, for the concurrent DTDMA cycle on the local channel using the control packet for the cycle and then transmits the data on the second channel as time permits during the times transmission on transmit-allowed times if transmission criteria for second channel are met, as represented by blocks 410, 412, 414, 416, and 418.

The processes represented by blocks 410 and 412 represent the process of the protecting radio determining transmit-allowed times during the concurrent DTDMA cycle on the local channel.

Block 410 represents processes of the protecting radio determining transmit-allowed times based at least in part on a time resource allocation for the cycle described in the control packet transmitted on the local channel by the base radio. As described above, an ITCnet control packet describes the dynamic allocation of time resources within its associated DTDMA cycle, including allocation of times, if any, to the base radio to transmit, which is equivalent to the receive times for all remote radios registered with the base radio, and allocation of times, if any, for remote radios to transmit to the base radio, which are equivalent to receive time for the base radio. When the protecting radio processes the control packet for the DTDMA frame, it may do so with awareness of any allocations to the protected radio, as described in connection with block 412.

Time resources for transmitting during a cycle are dynamically allocated between the base radio and remote radios. Although time resources allocations could be made by allocating fixed or variable length slots on a slot-by-slot basis, ITCnet allocates, in effect, groups of time slots during a DTDMA cycle using fields. A field is a length of time during a DTDMA cycle for either base radio transmissions or remote radio transmissions. Current DTDMA fields are described above. These fields include, in addition to a control (CTL) field, which are times during the cycle allocated to the base radio to transmit the RF control packet; a base radio transmit (B-TX) field which is allocated to the base radio to transmit unicast packets carrying outbound data traffic to remote radios; a remote transmit (R-TX) field allocated to remote radios to transmit unicast RF packets to the base radio carrying inbound data traffic from remote radios, each time slot within the field being assigned to a remote radio to transmit a unicast RF packet to the base radio; a high-priority CSMA (HP-CSMA) field allocated to any remote radio to transmit RF packets to the base radio to request a time slot in the R-TX field to transmit data to the base radio; and all-priority CSMA (AP-CSMA) field for any remote radio to transmit and RF packet to the base radio to request a time slot in the R-TX field to transmit to the base radio data of any priority. Unused fields during a cycle are given a 0 length. These fields are examples and not limiting.

During block 410, the protecting radio determines time resource allocations for the concurrent DTDMA cycle from the control packet received during block 406 at the beginning of the cycle. It determines which times during the cycle allocated to the base radio to transmit and to remote radios to transmit. Because the base radio may be transmitting broadcast or unicast packets intended for consumption by the protected radio, times allocated the base radio to transmit are at least presumed to be times during which transmissions on another channel by the protecting radio should be inhibited, subject to any exceptions, such as situations in which the data that the protecting radio needs to transmit has a higher priority, such as those described above. For radios that operate in a half-duplex mode-ITCnet radios operate in a half-duplex mode-times during which a protected radio is transmitting means it is not receiving and therefore does not need to be protected from radio de-sense interference. The DTDMA partition of the local channel in ITCnet is used for communications between a base radio and remote radios and not between remote radios. It may therefore be assumed that the protected radio does not need to be protected during any times allocated to remote radios to transmit. The protecting radio may treat such times as transmit-allowed times or periods, during which the protecting radio need not inhibit transmissions to protect the protected radio from radio de-sense interference on the local channel.

In a representative, nonlimiting example of an ITCnet embodiment, the protecting radio is configured or adapted to determine times corresponding to the control field, in which the base radio broadcasts the control packet as transmit-inhibited times because the protected radio will always need to be able to receive it. Similarly, the protecting radio is configured to determine as a default that times that the base radio allocates to itself transmit of unicast (or possibly also multi-cast or broadcast) RF packets times transmit-inhibited because it is possible that one of the RF packets contains a message intended for the protected radio. Therefore, in the illustrated embodiment, the protecting radio is configured to determine from the time allocation in the control packet times allocated for the control field and which times, if any, during the cycle are allocated to a B-TX field and to treat by default those times as transmit-inhibited times unless it can be otherwise determined that packets being transmitted are not intended to be consumed by the protected radio or there is an exception that allows the protecting radio to transmit during those times. The protecting radio can be configured to determines times in the remaining fields—the R-TX, HP-CSMA, and AP-CSMA fields—as transmit-allowed.

Block 412 represents additional processing, which is optional, in which the protecting radio is configured to determine whether any of the times in the B-TX, which are allocated to the base radio to transmit unicast packets to connected remote radios, are for packets transmitted to remote radios other than the protected radio. If so, the protecting radio can be configured to treat those times as transmit-allowed because the protected radio will not need to be able to receive those packets.

One method for making this determination, is obtain from the serving base radio awareness of any scheduled unicast packets intended for consumption by the protected radio. One method for obtaining this awareness is to have the serving base provide times that it has scheduled to transmit unicast packets to the protecting radio. The protection service described above in connection with FIG. 3 is an example of such a service. Once the protecting radio subscribes, the base radio transmits to protecting radio one or more scheduled transmission times for one or more unicast packets intended for consumption by the protected radio. The subscription services packet is sent in the B-TX field of a prior DTDMA cycle. If the protecting radio is aware of the times for any scheduled transmissions of unicast packets to the protected radio during the B-TX field in the concurrent DTDMA cycle, the protecting radio is configured to determine those times as transmit-inhibited times and treat any remaining times in the B-TX field as transmit-allowed times. It may make this determination based on, for example, a protection services packet always including all scheduled transmission times for the protected radio during a B-TX of a DTDMA cycle. Therefore, if there is a time (which can be a slot, for example) for a unicast packet scheduled for the concurrent cycle, the protecting radio may be configured to assume that any times or slots in the B-TX of the concurrent cycle are transmit allowed. Note that multiple unicast packets may, optionally be scheduled for the protected radio in the B-TX field of the concurrent DTDMA cycle and that the protection services packet may, optionally, include scheduled unicast packets for the protected radio for multiple DTDMA cycles.

For B-TX fields during which none of the transmissions will be a packet intended for consumption by the protected radio, the protecting radio may be configured to determine that the entire B-TX field is transmit allowed if it is aware that no packets are scheduled for the protected radio during the cycle.

This determination can be based on the content of protection services packet, when a protection services packet is expected, and/or the ability to receive a protection services packet, if sent, for B-TX field in the concurrent cycle.

For example, if the base radio transmits a protection services packet that, based on its contents, covers multiple cycles, the protecting radio may be configured to treat all times during the B-TX fields in the cycles as transmit-allowed except for any times scheduled for a unicast packet intended for the protected radio.

In another example, the protecting radio may be configured to expect to receive a protection services packet from the serving base radio in a prior DTDMA cycle or in a predetermined number of prior cycles or at some point during the DTDMA frame that includes the concurrent DTDMA cycled for any scheduled transmission for the protected radio in the concurrent cycle. If it does not receive a protection services packet when expected for any transmissions scheduled to the protected radio, it can be configured to determine that the entire B-TX in concurrent cycle is transmit allowed. Before making this determination, the protecting radio is preferably, but optionally, configured as described above in FIG. 3 to ensure that protecting radio's subscription for the serving base station's protection services is active and the protected radio is connected to the serving base for the concurrent DTDMA cycle. The protecting radio may also be configured to ensure that it has been listening to the local channel and able to receive packets during B-TX fields of any prior cycle during which it would expect to receive a protection services packet for the concurrent cycle. Thus, in this example, the protecting radio is configured to wait until it completes the registration process with the serving base radio before transmitting on the second channel during a B-TX field unless it has, optionally, been configured to treat the B-TX field times as transmit-allowed times for high priority traffic such as emergency traffic. For an ITCnet implementation, ITCnet protocols supports assigning priority levels to messages that are being transmitted by radios. This allows the protecting radio to be configured to differentiate normal priority traffic, which does not have priority over traffic on the local channel for the protected radio, and emergency traffic, which the protecting radio may give priority to over traffic on the local channel when transmitting on a DirectRF channel.

Although the B-TX field in ITCnet is used for unicast packets, the methods may, optionally, be extended to other types of packets, such as multicast and broadcast packets. In addition, the methods

As indicated by decision blocks 414, 416 and 418, when transmission criteria are met on the second channel during a transmit-allowed period or time for the concurrent cycle, the protecting radio transmits packets in its queue as permitted on the second channel. In the illustrated process, which is a representative and nonlimiting example, processing represented by blocks 406, 408, 410, 412, 414, 416, and 418 are repeated for each field in the concurrent DTDMA cycle.

In the example of ITCnet, decision block 414 represents the protecting radio using a CSMA process to transmit one or more of RF packets in its queue during transmit-allowed times of the concurrent DTDMA cycle. If the field is transmit-allowed or, the B-TX field includes transmit-allowed times, the protected radio transmits as time permits during the field data in its queue on the second channel (the DirectRF Channel in our example) if CSMA transmission criteria are met. Once the field ends for the concurrent cycle run end, the protecting radio holds off further transmissions, as represented by the return to block 404 and repeats the processing represented by blocks 406, 408, 410, 412, 414, 416, and 418 for the next field in the concurrent DTDMA cycle.

Alternatively, for example, processing represented by blocks 410 and 412 may be performed for an entire DTDMA cycle based on the control packet for the concurrent DTDMA cycle, with transmission processes of the protecting radio for the second radio occurring during transmit-allowed times while holding off transmissions during transmit-inhibited times, until all of the data or packets in its transmit queue has been transmitted or the concurrent cycle ends, at which point it returns to block 404.

If the base radio has a large message to transmit to the protected radio, it could, for example, choose to break it into multiple parts and schedule in multiple cycles transmission of a unicast packet for each part. In ITCnet, for example, the base radio could, schedule a unicast packet to send each in multiple DTDMA cycles within the concurrent DTDMA frame or partition and send a single protection services packet that includes the scheduled transmission times of the all the unicast packets for the message. The protection services packet for the protected radio would thus cover multiple DTDMA cycles.

Note that the processes of FIG. 4 assume that the protecting radio is programmed to inhibit transmitting on DirectRF channels during an FTDMA cycle on the local channel.

Furthermore, FIG. 4 does not illustrate exceptions that would allow the protecting radio to be figured to transmit on a DirectRF channel even during transmit-inhibited times. An example of an exception is when it has latency intolerant emergency traffic to transmit. Such traffic can be treated as having a higher priority than traffic on the local channel intended for the protected radio. Furthermore, the processes of FIG. 4 can be extended to consider the priority of RF packets transmitted by the base radio to the protected radio when determining transmit-allowed times and/or exceptions to transmit-inhibited times if such information is available to the protecting radio. This information could be available if, for example, the wireless train control network supported allocation of fields to the base radio for high priority base radio transmissions and all-priority base radio transmissions. It could also be available from a protection services packet if, for example, the base radio includes priority information for the RF packet (or the data carried by it) or the protection services packet only included scheduled packets for the protected radio that were high prior priority.

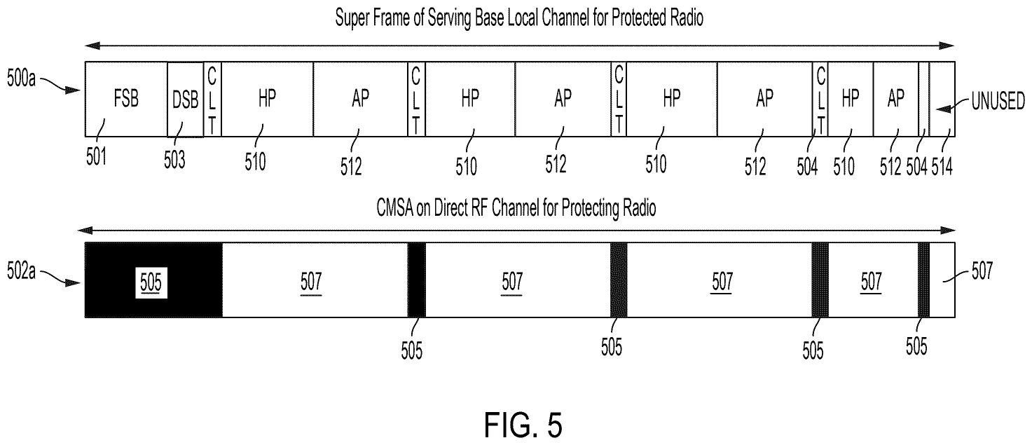

With reference now to FIGS. 5 to 10, each of these figures has two concurrent timelines that correspond in length to an ITCnet super frame for a local channel. The upper timeline, referenced respectively in FIGS. 5-10 as timelines 500a to 500f, represent different, nonlimiting examples of real-time scenarios of a serving base station for the local channel dynamically organizing a DTDMA partition of the super frame time.

The lower timeline, referenced in the figures as timelines 502a to 502f represent corresponding times in which a protecting radio should not transmit on the second channel, referred to as transmit-inhibited periods 505, to avoid interfering with a protected radio's ability to receive time-sensitive and/or important transmissions on the local channel during the super frame and, conversely, times in which it may transmit on the second channel without interfering, which are indicated as transmit-allowed or transmit-eligible periods 507 on the second channel timeline. During the transmit-inhibited periods of at least the DTDMA partition of a super frame, the protecting radio protects the protected radio's ability to receive by refraining from transmitting on the second channel, subject to any predetermined exceptions. Because transmissions to the protected radio are dynamically scheduled DTDMA partition, the protecting radio must determine transmit-eligible and transmit-inhibited times or periods based at least in part of the allocation of the DTDMA cycles, fields, and slot assignments for each super frame using, for example, the processes disclosed in connection with FIGS. 2-4.

The second channel is, in these examples, an ITCnet DirectRF channel. In ITCnet, a co-located radio not having priority will likely not be transmitting on the channel. However, in other implementations, the channel could be any channel that uses CSMA or, possibly, other channels that are centrally organized if, for example, they have lower priority.

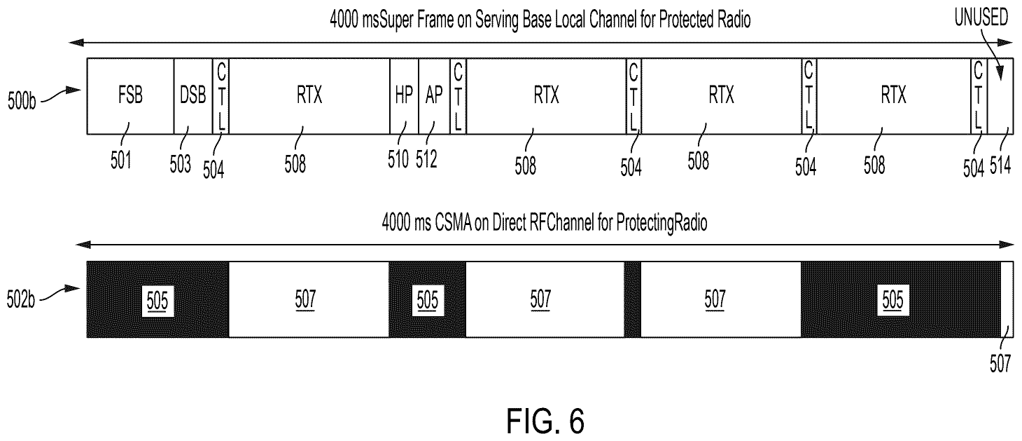

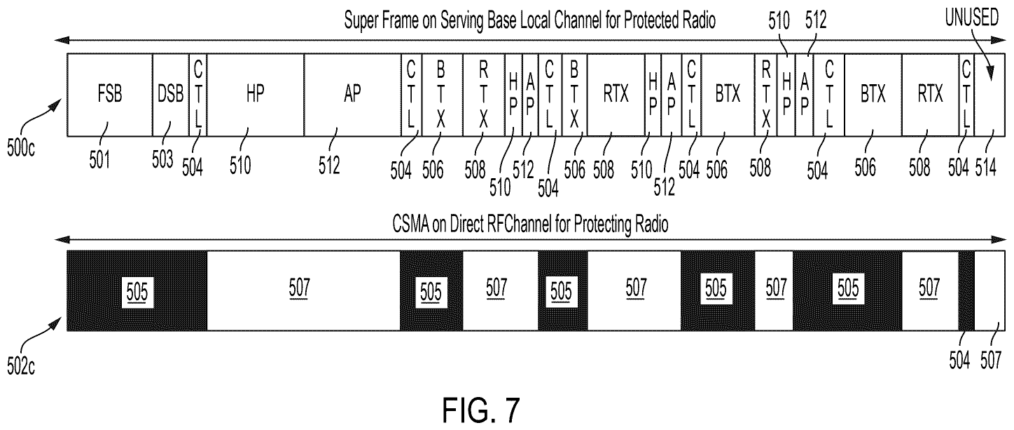

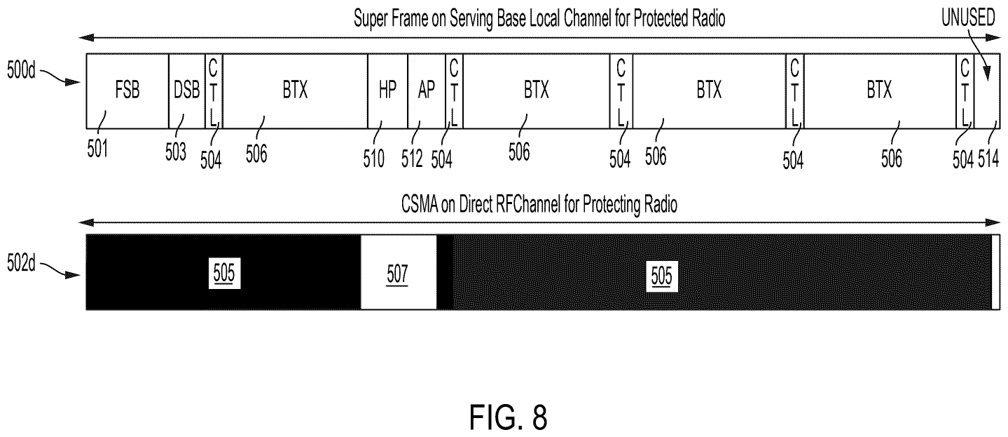

FIG. 5 represents an example of an idle channel with transmission availability distributed using a real-time scenario for remote radios to transmit a request to the base radio for a time slot to send data to the base radio. FIG. 6 represents an example uplink loaded local channel with a transmission availability distributed in a real-time scenario. FIG. 7 represents an example of a real time scenario for a balance loaded local channel, with transmission availability for remote radios distributed in a real-time scenario. FIGS. 8, 9, and 10 represent examples of a downlink loaded local channel with transmission availability distributed in a real time scenario. Many scenarios are possible. These are intended to be merely to illustrate and explain. Although the examples are given in reference to an ITCnet wireless network for train control, the concepts illustrated by the figures can be adapted to non-ITCnet wireless train control networks.

FSB fields 501 and DSB fields 503 are part of a fixed-length FTDMA cycle that is used in ITCnet for wayside radios to broadcast wayside status messages directly to locomotives in its vicinity. As mentioned above, access to a local channel in the ITCnet radio network is based on a repeating fixed-length time cycle called a “super frame” that is divided into a “fixed” TDMA portion (FTDMA) and a “dynamic” TDMA (DTDMA) portion. As discussed above, the allocation of channel access time to the FTDMA is fixed and occurs in the same position in the super frame during each of its cycles. The FTDMA is used in ITCnet for a remote radio at a wayside monitoring subsystem to transmit status messages to base radios and locomotives in its vicinity. A base radio does not manage access to it. Therefore, the methods disclosed herein assume that the FTDMA will occur in the same position within superframe and have the same duration each cycle of the super frame. The methods disclosed herein do not, however, require and are not limited to access schemes with FTDMA partitions.

When, for example, the protected radio is the radio ultimately responsible for participating in train movement enforcement for Positive Train Control, the protecting radio is, in the illustrated examples, configured to treat the times corresponding to the FSB and DSB fields as transmit-inhibited times on direct channels for the protecting radio. The protected radio in a locomotive is intended in ITCnet to be able to receive wayside status messages and forward them to a train management computer in the locomotive.

Therefore, in each of the scenarios of FIGS. 5-10, a period on the eligibility timeline corresponding to the FSB or DSB fields is treated as a transmit-inhibited period 505. However, the protecting radio may, optionally, be configured with one or more exceptions to the default transmit-inhibited state, such as for latency intolerant emergency traffic that needs to be send by the protecting radio.

As previously described, the base radio dynamically manages allocation of the time in the DTDMA portion using a basic access scheme that allows for variable length DTDMA cycles and variable length fields within each cycle. The access scheme permits the base station to dynamically set the number of DTDMA cycles and length of each DTDMA cycle during the DTDMA portion of the super frame. A DTDMA cycle includes a non-zero length control or CLT field 504 and at least one field of non-zero length. In ITCnet, a DTDMA field other than a CLT field may have a zero length during a cycle, which means it not being used for that cycle. In the example scenarios, there are four additional fields: B-TX fields 506, R-TX field 508, HP-CSMA field 510, and AP-CSMA field 512. Any time in a DTDMA partition that is not allocated is indicated on the local channel timelines in the scenarios as an “unused” portion 514.

CLT fields 504 represents time reserved for the base radio to broadcast a control packet. The protecting radio is configured to treat these periods as ineligible for transmission on the direct channel. Both protecting and protected radios need to be able to receive the control packets to know how the base radio has scheduled a DTDMA cycle. In ITCnet, the first CTL field is at the beginning of the DTDMA partition by default. A control message is sent at the beginning of each subsequent DTDMA cycle until the end of the DTDMA partition, including before any unused portion 514. The protecting radio and the protected radio need to be able to receive the control packets to know how the base radio has scheduled the time cycle. The corresponding time blocks on each of the second channels timelines 502a to 502f are therefore always transmit-inhibited periods 505.

B-TX fields 506, labelled “BTX” in the figures, are shown in the scenarios of FIGS. 7, 8, 9 and 10. The base radio allocates in each B-TX field one or more B-TX time slots, each slot being used to transmit a unicast packet to a specific remote radio connected with the base radio, typically in a locomotive, which contains data message intended for the remote radio. The base radio notifies the remote radio by including its radio ID in a slot assignment in the CTL packet. the protecting radio is configured to treat by default these times as transmission-inhibited on the direct channel because one or more of the unicast packets may be intended for the protected radio. However, the protecting radio is, in these examples, configured to attempt to determine whether there is any time in a B-TX field assigned to transmitting packets to remote radios other than the protected radio. Any transmissions during these times do not need to be received by the remote radio. If the protecting radio can determine that the protected radio is not scheduled to receive packets from the base radio in DTDMA cycle or that none of the B-TX slots in a B-TX field of a cycle are assigned to the protected radio, the protecting radio may treat the period corresponding to the B-TX field as transmit-eligible. If a B-TX slot in a B-TX field is assigned to the protected radio, the protecting radio will treat times corresponding to any remaining B-TX slots in the B-TX field as transmit-eligible.

In scenario of local channel timelines 500c and 500d of FIGS. 7 and 8, there are five DTDMA cycles in FIG. 7 and four in FIG. 8, each beginning with a CTL field 504. The protecting radio has determined that the times corresponding to the B-TX field 506 in each of the first five DTDMA cycles of FIG. 7 and each of the first four DTMDA cycles in FIG. 8 are transmit-inhibited periods 505. In these scenarios, the protecting radio was unable was not able to determine which, if any, of the unicast packets scheduled transmission in a B-TX field were intended for the protected radio and therefore treated the times corresponding to the B-TX field as transmit-inhibited by default.

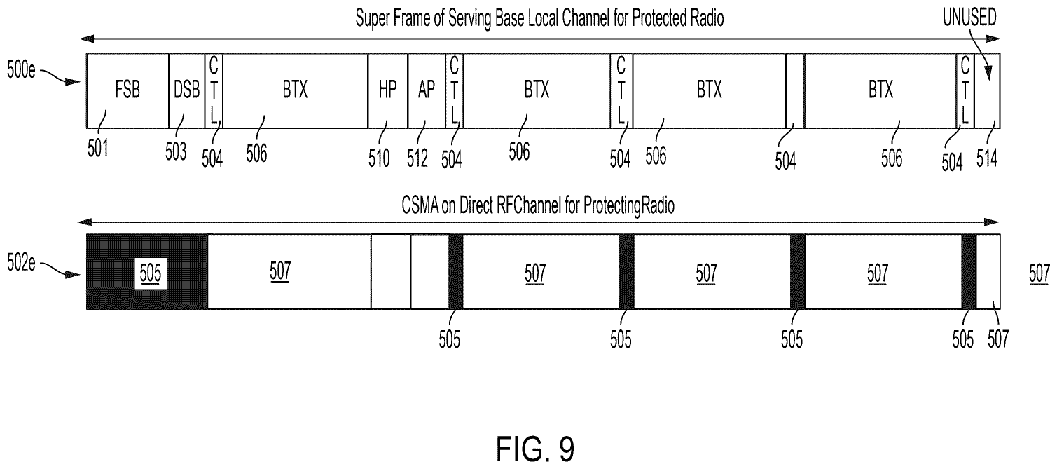

On the other hand, in the local channel timeline 500e of the scenario illustrated by FIG. 9, the protecting radio was able to determine that none of the transmissions in the BTX field 506 in each of the four DTDMA cycles were intended for the protected radio. The local channel timeline 500e indicates that the base radio allocated four DTDMA cycles, each starting with CLT field 504. In the first cycle, the base radio has allocated time slots to a B-TX field 506, an HP-CSMA field 510 and an HP-CSMA field 512. In the remaining three DTDMA cycles, the base station has allocated a single B-TX field 506 for base radio transmissions.

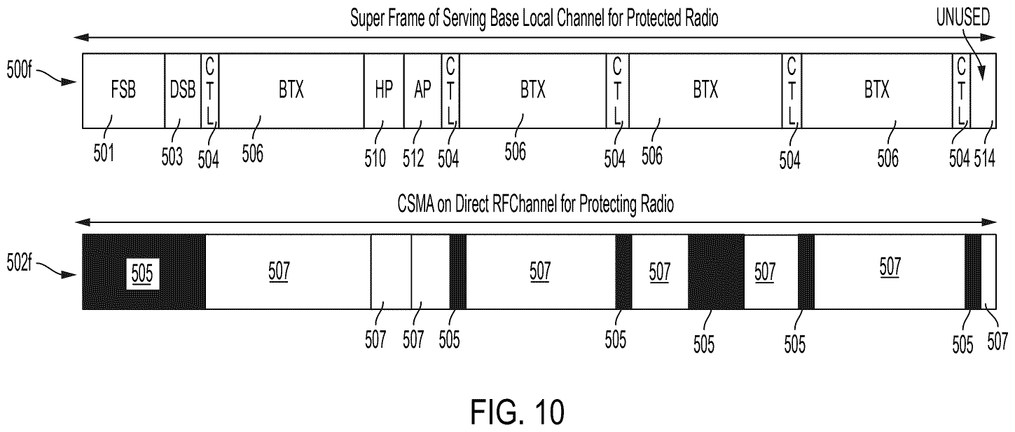

The local channel timeline 500f in FIG. 10 has the same cycle and field allocations as timeline 500e in FIG. 9. However, in this scenario, the base radio has scheduled a time slot to transmit a unicast packet intended for consumption by the protected radio only in the B-TX field 506 during the third DTDMA cycle. The protecting radio has identified this time slot and thus determined that the corresponding times on the second channel are transmit-inhibited. The second channel timeline 502F indicates a transmit-inhibited period 505 at the times corresponding to this time slot. The protecting radio has also determined that the protected radio will not be receiving unicast messages from the base in other time slots of the B-TX field in the third cycle or in the B-TX fields in the first, second, fourth DTDMA cycles. Therefore, the corresponding times are treated as transmit-eligible periods 507 on the second channel timeline 502f.

In the scenarios of FIGS. 6 and 7, local channel timelines 500b and 500c indicate that base radio has allocated R-TX fields 508 (labelled “RTX”) in several DTDMA cycles on the local channel. In FIG. 6, there are four cycles, each with an RT-X field. In FIG. 7 there are five DTDMA cycles, second to fifth having an R-TX field 508. The base radio schedules and assigns each R-TX time slot to a remote radio for it transmit to the base station a unicast packet carrying traffic intended for a back office. As indicated in second channel timelines 502b and 502c, the protecting radio is configured to the times corresponding to R-TX fields as a transmit-eligible periods 507. The protected radio is not expected to need to be able to receive packets during these times. The base radio will not be transmitting on the local channel any packets during these times. Because remote radios in ITCnet currently operate in a half-duplex mode on the local channel, the protected radio will either be transmitting on the local channel or idle. Any transmissions on the local channel during these periods will therefore only be from non-protected remote radios, which are transmitting unicast packets intended for the base radio. In other embodiments in which the protected radio is a full-duplex radio, it might not be possible to assume that the protected radio is not capable of receiving transmissions while it is transmitting.

In scenarios of each of FIGS. 5-10, the base radio has allocated in at least one DTDM cycle at least one HP-CSMA field 510 (labelled “HP” in the figures) and AP-CSMA field 512 (labelled “AP” in the figures). Each of these fields allocate one or more CSMA time slots for remote radios to use to send and RF packet to the base radio requesting access to the local channel to transmit to the base station RF packets containing a message data intended for a back office. High priority requests are sent in a CSMA time slot in the HP-CSMA field 510. A request of any priority can be sent in a CSMA time slot in the AP-CSMA field. The CSMA time slots are not assigned to any remote radio. Access to the local channel relies on a CSMA scheme mentioned above. The base radio acknowledges a request in a subsequent control packet and notifies the remote radio in a control packet of an assignment of one or more time slots in an R-TX field for the remote radio to transmit. As indicated on the second channel times 502a, 502b, 502c, 502d, 502e, and 502f, the protecting radio is configured by default to treat times corresponding to HP-CSMA fields and AP-CSMA fields as transmit-eligible periods 507 for the protecting radio. The protected radio will be either transmitting a request and thus not able to receive because ITCnet radios are half-duplex, or idle because other remote radios will be accessing the local channel.

The “unused” portion 514 of the local channel timelines are unallocated time resources during in DTDMA partition. The unused portions are preceded by a CTL field. The unallocated time is too small to be useful to a base station for any queued traffic. The base radio scheduling process abandons these time resources. Because they may be sufficient for use by the protecting radio to transmit on a direct channel, the processes on the protecting radio can be configured to determine what these periods are and treat them transmit-eligible periods 507.

Processes illustrated in the accompanying figures are explanatory and do not imply that processing represented by blocks or steps must be performed sequentially in the illustrated order; that processing represented by different blocks or steps cannot be performed concurrently with processing represented by other blocks; that any processing represented by a step or block is required for other processing steps in the process; that processing represented by a step or block cannot be combined with processing represented by other steps or blocks; or that processing represented by blocks or steps cannot be executed in a different order; or that a processing step or block cannot be omitted or made dependent on other processes or conditions.

The preceding description of examples and embodiments, including preferred embodiments, are, unless otherwise noted, representative and nonlimiting examples of possible implementations, embodiments, and uses embodying claimed subject matter to explain the principles of the claimed subject matter and how it can be put into practice to satisfying applicable disclosure legal requirements. Modifications and substitutions can be made to disclosed embodiments, including alternative embodiments, without departing from the scope of the appended claims. Such modifications and substitutions include those that would be known to persons of ordinary skill in the relevant art or technical field or understood by such persons from the preceding disclosure.

The use of the term “may” should be interpreted in its normal sense as expressing a possibility and not a requirement, even when not accompanied by the word “option” or “optionally.” No feature, aspect, or element is essential unless explicitly identified to be. The meanings of the terms used in this specification are, unless otherwise defined, intended to have their ordinary and customary meaning to those in the relevant art. The meaning of a term is not intended to be limited to or defined by the specific structures or acts that it identifies in any figures. A structure or act referenced by a common term for a class of structures or acts is only a representative example of that structure or act. Limitations described for an element in one embodiment do not limit the same or similar element in another embodiment unless otherwise stated in the description of that embodiment.

The terms “comprise,” “have,” “include,” “contain,” and “involve,” and variations of them are open-ended linking verbs that signal a nonexclusive listing and thus permit the addition of other elements. When used in claims, the term “comprising” should be interpreted in the manner typically done in patents, which is “including but not limited to.” On the other hand, the phrase “consisting of,” when used in a claim, implies a closed set of elements. When used in a claim, the phrase “consisting essentially of” excludes additional material elements but allows the inclusion of non-material elements. A material element substantively modifies, adds to, or subtracts from the functionality or nature of the subject matter recited in the claim. If the specification states a component or feature “may,” “can,” “could,” “should,” “would,” “preferably,” “possibly,” “typically,” “optionally,” “for example,” “often,” or “might” (or other such language) be included or have a characteristic, that component or feature is not required to be included or to have the mentioned characteristic. Such a component, feature, or characteristic may be included or excluded.

A singular form of an element or components of an apparatus described herein is understood to include its plural form. Use of the word “a” or “an” when used in conjunction with the term “comprising” in the claims or the specification means one or more than one unless context would otherwise make it indefinite. The term “or” in the claims is used to mean “and/or” unless explicitly indicated to refer to alternatives only or if the alternatives are mutually exclusive. The terms “couple,” “coupled,” “connect,” “connection,” “connected,” “in connection with,” and “connecting” refer to “in direct connection with,” “integral with,” or “in connection with via one or more intermediate elements or members.

What is claim is:

1. In a wireless railroad control network having a plurality of channels including a first channel assigned to an managed at least partially by a base radio and at least a second channel that is not managed by a base radio, the base radio allocating dynamically to the base radio and remote radios connected with the base radio on the first channel at least some of time resources of the first channel using time division multiple access (TDMA), the base radio being further configured to transmit control packets identifying time resource allocations for TDMA cycles, a method to mitigate radio de-sense interference of a first remote radio connected to the base radio on the first channel caused by transmissions on a second channel by a second remote radio co-located with the first remote radio, wherein the second remote radio is configured for a process comprising:
listening to the first channel and processing control packets transmitted by the base radio on the first channel, each control packet containing time resource allocations for at least part of a TDMA cycle on the first channel;
based at least in part on the time resource allocation in the control packet, determining transmit-allowed times during a dynamically allocated TDMA cycle based at least in part on the time resource allocation in the control packet for the cycle, the transmit-allowed times excluding times during which the base radio is transmitting RF packets on the first channel intended for consumption by the first remote radio; and
inhibiting transmitting on the second channel during times that are not transmit-eligible times.

2. The method of claim 1, wherein transmit-allowed times exclude times allocated in the time resource allocation for the base radio to transmit unicast RF packets to remote radios connected to the base radio.

3. The method of claim 1, wherein transmit-allowed times exclude times allocated in the time resource allocation to the base radio to transmit one or more unicast RF packets intended for consumption by the first remote radio.

4. The method of claim 1 wherein transmit-allowed times comprise times allocated in the time resource allocation for the base radio to transmit RF packets to remote radios connected with the base radio other than the first remote radio.

5. The method of claim 1, wherein the second remote radio is configured to receive from the base radio a schedule of transmission times for unicast packets from the base radio to the first remote radio and, wherein to determine transmit-allowed times further comprises determining times allocated to the base radio to transmit unicast RF packets to remote radios, excluding transmission times for unicast packets to the first remote radio, are transmit allowed times.

6. The method of claim 5, wherein process further comprises connecting to the base radio and transmitting to the base radio and transmitting a request to receive from the base radio the schedule of transmission times for unicast packets from the base radio to the first remote radio.

7. The method of claim 1, wherein transmit-allowed times exclude times allocated in the time resource allocation to the base radio to transmit control packets.

8. The method of claim 1, wherein transmit-allowed times include times allocated in the time resource allocation to remote radios to transmit RF packets.

9. The method of claim 1, wherein inhibiting transmissions on the second channel during times that are not transmit-allowed times comprises not transmitting on the second channel a queued packet when the second channel is available for transmitting the queued packet.

10. The method of claim 1, wherein,
the TDMA cycle is comprised of multiple variable length fields, each field corresponding to time resources allocated to the base radio to transmit or to one or more remote radios to transmit on the first channel; and
the time resource allocation indicates a length for each field.

11. The method of claim 10, wherein the TDMA cycle is an ITCnet DTDMA cycle and wherein the fields include a B-TX field during the base radio may transmit unicast packets to remote radios, an R-TX field during which remote radios transmit unicast RF packets to the base radio in assigned time slots, and one or more CSMA fields during which a remote radio may transmit a request an R-TX field time slot on the first channel to transmit data to the base radio.

12. The method of claim 1, wherein the process further comprises receiving from the first remote radio an identifier of the base radio and determining from the identifier of the base radio which of a plurality of channels is the first channel.

13. A software-defined remote radio for a wireless train control network, the radio comprising:
a receiver for a receiving for simultaneously receiving and processing digital RF packets transmitted on multiple channels of a wireless train control network; and
a transmitter capable of transmitting on any one of the multiple channels;
wherein the remote radio is configured with a process for protecting a co-located remote radio connected on a first channel to a serving base radio from radio de-sense interference, the process comprising:
listening to a first channel and processing control packets transmitted by the base radio on the first channel, each control packet containing time resource allocations for at least part of a time divided multiple access (TDMA) cycle on the first channel;
based at least in part on the time resource allocation in the control packet, determining transmit-allowed times during the TDMA cycle based at least in part on the time resource allocation in the control packet for the cycle, the transmit-allowed times excluding times during which the base radio is transmitting on the first channel RF packets intended for consumption by the first remote radio; and
inhibiting transmitting on a second channel during times that are not transmit-allowed times.

14. The remote radio of claim 13, wherein transmit-allowed times exclude times allocated in the time resource allocation for the base radio to transmit unicast RF packets to remote radios connected to the base radio.

15. The remote radio of claim 13, wherein transmit-allowed times exclude times allocated in the time resource allocation to the base radio to transmit one or more unicast RF packets intended for consumption by the first remote radio.

16. The remote radio of claim 13 wherein transmit-allowed times comprise times allocated in the time resource allocation for the base radio to transmit RF packets to remote radios connected with the base radio other than the first remote radio.

17. The remote radio of claim 13, wherein the second remote radio is configured to receive from the base radio a schedule of transmission times for unicast packets from the base radio to the first remote radio and, wherein to determine transmit-allowed times further comprises determining times allocated to the base radio to transmit unicast RF packets to remote radios, excluding transmission times for unicast packets to the first remote radio, are transmit allowed times.

18. The remote radio of claim 17, wherein the process further comprises connecting to the base radio and transmitting to the base radio and transmitting a request to receive from the base radio the schedule of transmission times for unicast packets from the base radio to the first remote radio.

19. The remote radio of claim 13, wherein transmit-allowed times exclude times allocated in the time resource allocation to the base radio to transmit control packets.

20. The remote radio of claim 13, wherein transmit-allowed times include times allocated in the time resource allocation to remote radios to transmit RF packets.

21. The remote radio of claim 13, wherein inhibiting transmissions on the second channel during times that are not transmit-allowed times comprises not transmitting on the second channel a queued packet when the second channel is available for transmitting the queued packet.

22. The remote radio of claim 13, wherein,
the TDMA cycle is comprised of multiple variable-length fields, each field corresponding to time resources allocated to the base radio to transmit or to one or more remote radios to transmit on the first channel; and
the time resource allocation indicates a length for each field.

23. The remote radio of claim 22, wherein the TDMA cycle is an ITCnet DTDMA cycle and wherein the fields include a B-TX field during the base radio may transmit unicast packets to remote radios, an R-TX field during which remote radios transmit unicast RF packets to the base radio in assigned time slots, and one or more CSMA fields during which a remote radio may transmit a request an R-TX field time slot on the first channel to transmit data to the base radio.

24. The remote radio of claim 13, wherein the process further comprises receiving from the first remote radio an identifier of the base radio and determining from the identifier of the base radio which of a plurality of channels is the first channel.
